(19) United States
(12) Patent Application Publication
(10) Pub. No.: US 2013/0025500 A1
(43) Pub. Date: Jan. 31, 2013

(54) PROCESS FOR THE PRODUCTION OF A RHEOLOGY MODIFIER CONTAINING COMPOSTITION

(71) Applicants: Christopher Stephen JONES, Saint-Gilles (BE); Nuray YALDIZKAYA, Gent (BE); Raffaele PINNA, Brussels (BE); Jeroen TIDEMAN, Brussels (BE); Robby Renilde Francois KEULEERS, Lippelo (Sint Amands) (BE)

(72) Inventors: Christopher Stephen JONES, Saint-Gilles (BE); Nuray YALDIZKAYA, Gent (BE); Raffaele PINNA, Brussels (BE); Jeroen TIDEMAN, Brussels (BE); Robby Renilde Francois KEULEERS, Lippelo (Sint Amands) (BE)

(73) Assignee: The Procter & Gamble Company, Cincinnati, OH (US)

(21) Appl. No.: 13/548,289

(22) Filed: Jul. 13, 2012

Related U.S. Application Data
(60) Provisional application No. 61/512,127, filed on Jul. 27, 2011.

(30) Foreign Application Priority Data
Jul. 3, 2012 (EP) 12174799.2

(51) Int. Cl. C08L 1/26; C08L 5/00

(52) U.S. Cl. 106/162.9; 106/172.1; 106/194.2; 106/205.71; 106/205.72; 106/181.1

(57) ABSTRACT

A process for the production of a rheology modifier containing composition comprising the steps of: providing a rheology modifier, wherein said rheology modifier is selected from the group consisting of a water swellable polymer, a non-water soluble crystalline polymer, and mixtures thereof; providing a substantially anhydrous water-miscible liquid carrier; and dispersing said rheology modifier in said substantially anhydrous water-miscible liquid carrier to generate a slurry having a viscosity of less than 2000 mPas at 0.1 s⁻¹ and 20° C. when measured using an AR 1000 rheometer.

### FIELD OF INVENTION

The present invention relates to a process for generating a substantially air-free solution, and attain optimal rheology modifier dispersion prior to mixing with the remaining ingredients to generate the final composition. Non-limiting examples of final compositions that may be obtained are dishwashing compositions, hard surface cleaning and/or cleansing compositions, laundry and/or fabric care compositions. However, such process may also be used to generate lotions for wipes, toothpaste, and/or hair colorants.

### BACKGROUND OF THE INVENTION

It is generally known that properly dispersing a water swellable and/or non-water soluble crystalline rheology modifier in an aqueous medium prior to hydration is crucial. If the particles are not effectively dispersed, they will stick together, and the rapid hydration of the outer surface may result in a gel layer that will block access of water to the rest of the particles. This in turn often results in swollen lumps that can require significant additional time and shear to dissolve. Such lumps can clog the pipes and/or points of entry, particularly when using an in-line process, and may cause excessive air entrainment.

High shear mixing is commonly used to minimize the tendency of particles coming into contact and sticking with one another, thus facilitating the dissolution process. This however introduces disadvantages such as high air incorporation and high energy consumption. Low shear mixing requires careful attention to the dispersion technique and may take a longer time to complete the dispersion.

Conventional approaches for dispersing a water swellable and/or non-water soluble crystalline rheology modifier, particularly in powdered and/or solid form, involves the dispersion of the powder particles in an aqueous solvent, typically water.

The problem that arises with such conventional techniques is that air is incorporated and trapped into the mixture which, in turn, may introduce processability disadvantages in view of the resulting viscosity build-up upon the application of shear. The result being that already at the dispersion stage high shear may be required for correct dispersion of the solid particles.

The problem of viscosity build-up becomes particularly relevant if an activation step is required, following dispersion, particularly when the rheology modifier is a non-water soluble crystalline polymer such as Micro Fibil Cellulose (MFC). In such instances, the dispersion step is commonly followed by an activation step whereby the mixture undergoes intense high shear processing. An example of such process is illustrated in WO2009/101545A1.

The activation step serves to expand the cellulose portion to create a reticulated network of highly intermeshed fibers with a very high surface area. However, the presence of entrapped air at this stage may disrupt the generation of the desired reticulated network as such limiting the weight efficiency of the technology, more particularly in view of its ability to build yield into the final composition.

Therefore, all such processes have the problem of air building up in the mixture which in turn results in poor powder dispersion, dissolution time, and high energy requirements.

An attempt to remove air from similar mixtures has been to incorporate a separate and/or additional degassing (or deaeration) step in the process. This step includes holding and/or storing the composition for a sufficient amount of time to allow the gas (or air) to leave the composition. An example is illustrated in WO2011056953. Such degassing step, however, introduces a number of disadvantages such as increased waiting time, storage cost, production line inefficiencies, maintenance costs/resources, and so on.

A need still remains for a process that minimizes the air content of a mixture in an efficient and cost effective manner. It is particularly desirable to minimize the air content in-process. By “in-process” it is herein meant that there is no separate and/or additional deaereation step to remove the air, but rather, air is allowed to escape from the mixture during processing.

The process of the present invention enables to generate a substantially air-free and a homogeneous dispersion prior to mixing with the remaining ingredients of the final composition to solve the above stated problems in the prior art.

Advantages of the present invention include: reduced risk of micro organisms developing in the slurry in view of the substantial lack of water, reduced air entrapment, high slurry activity, low dissolution time, and low energy requirements.

In one aspect of the present invention, a further advantage comprises the reduced risk of caking which in turn enables higher slurry activity while minimizing air entrapment.

Other advantages of the present invention will become apparent to the person skilled in the art when reading the detailed description with reference to the figures.

### SUMMARY OF THE INVENTION

The invention relates to a process for the production of a rheology modifier containing composition comprising the steps of: providing a rheology modifier, wherein said rheology modifier is selected from the group consisting of a water swellable polymer, a non-water soluble crystalline polymer, and mixtures thereof; providing a substantially anhydrous water-miscible liquid carrier; and dispersing said rheology modifier in said substantially anhydrous water-miscible liquid carrier to generate a slurry having a viscosity of less than 2000 mPas at 0.1 s⁻¹ and 20° C. when measured using an AR 1000 rheometer.

### BRIEF DESCRIPTION OF THE DRAWINGS

FIG. 1 is a schematic diagram illustrating the process according to one embodiment of the present invention.

FIG. 2 is a schematic diagram illustrating the process according to one embodiment of the present invention.

### DETAILED DESCRIPTION OF THE INVENTION

As used herein “single phase composition” means that the liquid composition comprises not more than one visually identifiable liquid phase.

As used herein “multiphase composition” means that the liquid composition has substantially non-uniform chemical and/or physical properties such to generate more than one visually distinctive liquid phases.

As used herein “substantially air-free” means that the air content in the solution (or slurry) is less than 3%, preferably less than 2%, more preferably less than 1%, even more preferably less than 0.5%, still more preferably less than 0.2%, most preferably less than 0.1%, according to the test method described herein.

As used herein “substantially anhydrous water-miscible liquid carrier” means that the water-miscible liquid carrier does not contain more than 15%, preferably no more than 10%, more preferably no more than 5%, still more preferably less than 3%, most preferably less than 1%, of water by weight of the carrier.

As used herein “high intensity mixing” means a mixing step sufficient to activate the micro fibril cellulose (MFC) to provide the desired yield stress.

As used herein “low intensity mixing” means a mixing step sufficient to disperse a solid phase into a liquid phase or mixing two or more liquid phases to provide a single homogeneous phase.

As used herein “saturation” means the level of solid phase concentration after which point the slurry can no longer disperse and/or dissolve said solid phase without generating a precipitate and/or the viscosity exceeds 2000 mPas at 0.1 s⁻¹ and 20° C. using the test method described herein.

As used herein “activation” means the process through which crystalline fibers or pre-dispersed powder is allowed to create a more homogeneous dispersion network, as such providing enhanced yield stress to the final composition.

As used herein “yield stress” means the force required to initiate flow in a gel-like system. It is indicative of the suspension ability of a fluid, as well as indicative of the ability of the fluid to remain in situ after application to a vertical surface. The higher the yield stress, the greater the ability of the fluid to suspend solid particles.

As used herein “degassing” or “deaeration” means holding and/or storing the mixture and/or composition for a sufficient time to allow air to leave said composition and optionally applying additional processing steps such as generating a vacuum during the holding/storing to increase the rate of degassing.

As used herein “in-line process” or “continuous process” means that the process steps are followed in a continuous manner with minimal and/or no interruption by typically feeding ingredients directly into a continuous pipe to generate the final composition.

As used herein “batch process” means that the process steps are followed sequentially and wherein the time interval between said steps is greater than in an in-line process. Typically each process step is carried out in a vessel.

### Process

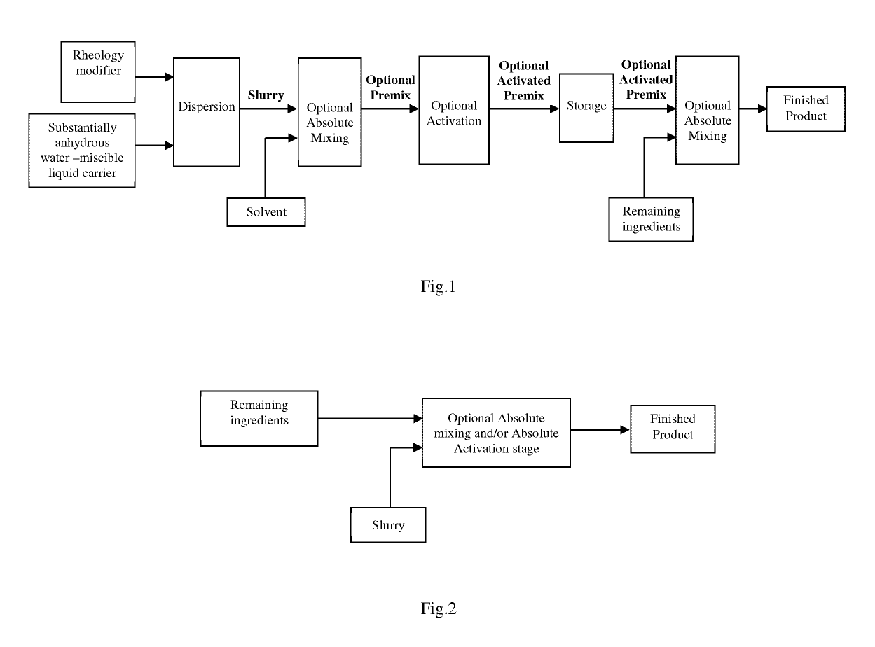

The process according to the present invention comprises a first stage and is typically followed by a number of subsequent stages. The first stage of the process comprises a slurry generation stage, said slurry generation stage may be followed by a premix generation stage, a premix activation stage and a final mixing stage, FIG. 1.

Alternatively, said slurry generation stage is followed by an absolute mixing stage and an absolute activation stage, FIG. 2.

The above stated order of stages is preferred, however variation in the order of said stages may be carried out without parting from the scope of the present invention. The different unit operations of the process of the invention maybe carried out under any flow regime, including laminar, transitional and turbulent regime.

Without wishing to be bound by theory, avoiding air entrainment at the start of the process (i.e. in the slurry generation stage) is challenging due to the addition of solid particles to generate a homogenous dispersion. Once a substantially air free slurry is generated, care must still be taken in order not to introduce substantial amounts of air in the process steps that follow, but may result from good design practices as known in the art.

### Slurry Generation Stage

The process for the production of a rheology modifier containing composition according to the present invention comprises the steps of: (a) providing a rheology modifier wherein said rheology modifier is a water swellable polymer and/or non-water soluble crystalline polymer, preferably in powder form; (b) providing a substantially anhydrous water-miscible liquid carrier; and (c) dispersing said water swellable polymer or non-water soluble crystalline polymer in the substantially anhydrous water-miscible liquid carrier to generate a slurry having a viscosity of less than 2000 mPas, preferably less than 1500 mPas, more preferably less than 1000 mPas, even more preferably less than 500 mPas, most preferably below 250 mPas, measured at 0.1 s⁻¹ and 20° C. using the test method described herein, preferably such slurry having said water swellable polymer and/or non-water soluble crystalline polymer fully dispersed therein to provide a stable slurry. Without wishing to be bound by theory, it is believed that a slurry with such viscosity ranges allows for natural deaeration in-process at room temperature and atmospheric pressure. By “natural deaeration” or “in-process deaeration” it is herein intended that the air is dissipated during processing without additional holding/storing steps. This is typically achieved when a substantially air-free slurry is generated in less than 20 minutes, preferably less than 15 minutes, more preferably less than 10 minutes, most preferably less than 5 minutes, using to the test method described herein.

In a preferred embodiment, the substantially anhydrous water-miscible liquid carrier has a viscosity of less than 2000 mPas, preferably less than 1500 mPas, more preferably less than 1000 mPas, even more preferably less than 500 mPas, even more preferably below 250 mPas, measured, most preferably below 100 mPas, at 0.1 s⁻¹ and 20° C. using the test method described herein.

Without wishing to be bound by theory it is believed that by ensuring that the viscosity of the initial slurry is kept low enough, fast dissipation of any air bubbles formed during dispersion of the rheology modifier in the carrier is enabled. This way, any air which is generated upon mixing is allowed to escape the slurry during the slurry generation stage, thus not requiring any dedicated deaeration stages.

Preparing a close to saturation point slurry, preferably while attaining a low viscosity, is desirable, particularly when the dispersion step is followed by subsequent process steps carried out in an in-line and/or continuous process set up. Without wishing to be bound by theory, the in-line process steps will then ensure that no additional air is introduced.

In a preferred embodiment said slurry is generated in a batch process. Without wishing to be bound by theory, it is believed that mixing liquids of significantly different rheology profiles (i.e. significantly different flow kinetics) in a in-line or continuous process set up is very hard and leads to a number of drawbacks. Indeed, when formulating a rheology modifier containing solution of a similar rheology profile as the base liquid, only very low levels of such rheology modifier can be added, typically up to 2% by weight, as such being far from the saturation point. Moreover, in a continuous or in-line process set up, any air that is present or is generated at the early stages of the process remains entrapped. This is not very effective in terms of storage inefficiencies and low activity, in addition to making the processing of concentrated low water liquid detergents more challenging in view of the low free water space to formulate into. On the other hand, this can be carried out in a batch process set up that allows more time for more homogenous mixing. Within a batch process a close to saturation rheology modifier containing solution can be generated. Preparing a close to saturation slurry prior to feeding in the in-line process aids in overcoming air incorporation, metering issues, line/pipe blockage issues which are otherwise inherent in a continuous or in-line set up. Feeding such batch generated slurry into a continuous and/or in-line process, then permits to maintain the abovementioned advantages through all remaining optional steps of the process.

The slurry can be generated in a tank which preferably includes a recirculation system.

The nature of the substantially anhydrous water-miscible liquid carrier is an important enabler of such low viscosity. Without wishing to be bound by theory it is believed that viscosity of the slurry will depend on the % wt of water present, wherein if too high a general viscosity build up is generated by the water swellable polymers or non-water soluble crystalline polymers which absorb such water and increase the effective yield stress of the liquid and prevents or dramatically slows natural de-airing of the air bubbles from the slurry. It is therefore desirable to effectively disperse such water swellable polymers or non-water soluble crystalline polymers with a substantially anhydrous water-miscible liquid carrier whilst minimizing the air content prior to any mixing with water.

In a preferred embodiment the process comprises the step of providing a poly-valent salt, preferably a polycarboxylate, more preferably a tri-valent salt, even more preferably tri-valent citrate, preferably having formula [C₃H₄OH(COO)₃]³⁻, to the slurry. The polyvalent salts described above aid in dramatically slowing down sedimentation and/or caking which may otherwise quickly result upon dispersion and handling of the rheology modifier, particularly at high solids content. By “high solids content” it is herein intended the level of rheology modifier at or close to the saturation point. Without wishing to be bound by theory it is believed that the polyvalent ions of the added salt are forming a electrical double-layer on the surface of the solid particles. This double-layer leads to an electrostatic repulsion force between the solid particles. Other interaction forces that are ever present between the particles are the attractive Van Der Waals force and the repulsive Born force. According to the DLVO theory (Derjaguin, Landau, Verwey and Overbeek theory) the total interaction force between particles consists of the sum of all the attractive and repulsive forces. The distances at which the forces of attraction exceed the forces of electrostatic repulsion are called the primary and secondary minimum. At these energy minima colloids can flocculate. Without electrostatic repulsion force the particles are flocking irreversibly at short distance in the primary minimum, leading to a solid cake that is extremely difficult to redisperse in the process. When adding an electrostatic repulsion force to the system through the addition of the above-mentioned salts, a weak flocculation of the solid particles into the secondary minimum further away from each other may occur. This weak flocculation is reversible, hence the formation of a solid cake is avoided and particles can be re-dispersed using low energy with simple agitation. As flocculation in the secondary minimum keeps particles further apart than flocculation in the primary minimum, also the suspension will be stabilized. An optimized suspension may be obtained through carefully tuning the system parameters. An optimized suspension has the following characteristics: a system with maximized solid load, at maximum stabilization, at minimum viscosity, in which no solid cakes are formed upon sedimentation and in which there is no yield-stress. Advantages of such embodiment include: increased activity of the slurry, reduced air entrapment and reduced risk of clogging and/or blockage.

When a poly-valent salt as described above is added to the slurry, the viscosity of the slurry may increase. However, it has been found that when the ratio of rheology modifier to poly-valent salt is between 1000:1 and 1:1, preferably between 500:1 and 5:1, more preferably between 200:1 and 10:1, even more preferably between 150:1 and 10:1, most preferably between 100:1 and 10:1, a correct balance between viscosity and stability of the slurry is achieved. It has been found that addition of the poly-valent salt at the cited ratios results in optimal natural deaeration and stability of the slurry.

In an embodiment said rheology modifier, preferably in powder form, is added in an amount from greater than 0% by weight of the slurry up to saturation, preferably at an amount equal to or close to saturation.

In a preferred embodiment step (c) is carried out at low intensity mixing.

In a preferred embodiment, air is allowed to escape from the slurry during and/or after the dispersion step of the water swellable polymer and/or non-water soluble crystalline polymer in the substantially anhydrous water-miscible liquid carrier.

In an embodiment, said substantially anhydrous water-miscible liquid carrier is selected from the group consisting of surfactants, humectants, polymers, oils, and mixtures thereof. Preferably, said anhydrous water-miscible liquid carrier is selected from the group consisting of surfactants, humectants and mixtures thereof. More preferably said anhydrous water-miscible liquid carrier is a surfactant, preferably a nonionic surfactant.

If the surfactant, humectant, polymer or oil used as carrier have a viscosity greater than the preferred ranges described herein, they are mixed with any of the other suitable anhydrous water-miscible liquid carriers in order to attain an overall viscosity within the ranges described herein.

Surfactants suitable as anhydrous water-miscible liquid carrier are selected from the group consisting of cationic surfactant, nonionic surfactant, and mixtures thereof. Most preferred surfactant suitable as anhydrous water-miscible liquid carrier is a nonionic surfactant. Other types of surfactants such as anionic including alkyl sulphates, alkylethoxysulphates, and alkylbenzenesulphonates, semi-polar including amine oxides or zwitterionic surfactants including betaines could also be considered however are less preferred as commercial variants typically comprise considerable amounts of water or are available as highly viscous pastes.

Nonionic surfactants suitable as anhydrous water-miscible liquid carrier include the condensation products of aliphatic alcohols with from 1 to 25 moles of ethylene oxide, propylene oxide or mixtures thereof. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol.

Also suitable are alkylpolyglycosides having the formula R²O(CₙH₂ₙO)ₜ(glycosyl)ₓ (formula (I)), wherein R² of formula (I) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (I) is 2 or 3, preferably 2; t of formula (I) is from 0 to 10, preferably 0; and x of formula (I) is from 1.3 to 10, preferably from 1.3 to 3, most preferably from 1.3 to 2.7. The glycosyl is preferably derived from glucose. Also suitable are alkylglycerol ethers and sorbitan esters.

Also suitable are fatty acid amide surfactants having the formula (II):

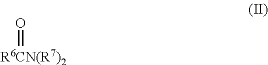

wherein R⁶ of formula (II) is an alkyl group containing from 7 to 21, preferably from 9 to 17, carbon atoms and each R⁷ of formula (II) is selected from the group consisting of hydrogen, C₁-C₄ alkyl, C₁-C₄ hydroxyalkyl, and —(C₂H₄O)ₓH where x of formula (II) varies from 1 to 3. Preferred amides are C₈-C₂₀ ammonia amides, monoethanolamides, diethanolamides, and isopropanolamides.

Most preferred nonionic surfactants are the condensation products of aliphatic alcohols and ethylene oxide, more particularly alcohol ethoxylates with a hydrophilic-lipophilic balance (HLB) number higher than 10. Even more preferred are alcohol ethoxylates with an HLB number higher than 12. Suitable examples include Neodol 91/8 from the Shell company and Lutensol XL79, XP99 or XP80 from the BASF company.

Cationic surfactants suitable as anhydrous water-miscible liquid carrier are quaternary ammonium surfactants. Suitable quaternary ammonium surfactants are selected from the group consisting of mono C₆-C₁₆, preferably C₆-C₁₀ N-alkyl or alkenyl ammonium surfactants, wherein the remaining N positions are substituted by methyl, hydroxyethyl or hydroxypropyl or substituted or unsubstituted benzyl groups. Another preferred cationic surfactant is an C₆-C₁₈ alkyl or alkenyl ester of a quaternary ammonium alcohol, such as quaternary chlorine esters. More preferably, the cationic surfactants have the formula (III):

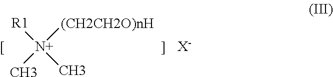

wherein R1 of formula (III) is C₈-C₁₈ hydrocarbyl and mixtures thereof, preferably, C₈₋₁₄ alkyl, more preferably, C₈, C₁₀ or C₁₂ alkyl, and X of formula (III) is an anion, preferably, chloride or bromide. Other preferred cationic surfactants are alkyl benzalkonium chloride or substituted alkylbenzalkonium chlorides such as the Barquat or Bardac line-ups from the Lonza company.

Humectants suitable herein include those substances that exhibit an affinity for water and help enhance the absorption of water onto a substrate. Specific non-limiting examples of particularly suitable humectants include glycerol; diglycerol; polyethyleneglycol (PEG-4) and its derivatives; propylene glycol; hexylene glycol; butylene glycol; (di)-propylene glycol; glyceryl triacetate; lactic acid; urea; polyols like sorbitol, xylitol and maltitol; polymeric polyols like polydextrose and mixtures thereof. Additional suitable humectants are polymeric humectants of the family of water soluble and/or swellable polysaccharides such as hyaluronic acid, chitosan and/or a fructose rich polysaccharide which is e.g. available as Fucogel®1000 (CAS-Nr 178463-23-5) by SOLABIA S. Further suitable humectants may be organic solvents, preferably polar protic or aprotic solvents characterized with a dipole moment greater than 1.5 D. Non-limiting examples include polar solvents selected from the group consisting of ketones, including acetone; esters, including methyl and ethyl acetate; alcohols; glycols; and mixtures thereof. Most preferred are alcohols, glycols or mixtures thereof.

Preferred alcohols are selected from the group consisting of ethanol, methanol, propanol, butanol, isopropyl alcohol, isobutyl alcohol and mixtures thereof, preferably ethanol. Preferred Glycols suitable as substantially anhydrous water miscible liquid carrier include ethylene glycol, propylene glycol, polethyleneglycol, polypropyleneglycol, and mixtures thereof.

Preferred polymers suitable as anhydrous water-miscible liquid carrier are charged polymers, preferably cationic polymers, more preferably quaternized polysaccharides. The quaternized polysaccharides polymers are preferably selected from the group consisting of cationic cellulose derivatives, cationic guars, cationic starch derivatives and mixtures thereof.

Oils suitable as anhydrous water-miscible liquid carrier are selected from the group consisting of mineral oil, perfumes, and mixtures thereof.

Water swellable polymers or hydrogels are suitable rheology modifiers and are characterized by the pronounced affinity of their chemical structures for aqueous solutions in which they swell. Polymers building rheology through generating a fibrous crystalline network when activated in a water solution are also suitable rheology modifiers, and are typically referred to as non-water soluble crystalline polymers. Such polymeric networks may range from being mildly absorbing, typically retaining 30% of water within their structure, to superabsorbing, where they retain many times their weight of aqueous fluids. Any natural, semi-synthetic or synthetic water-soluble and/or water swellable polymers may be employed to prepare the compositions of this invention.

The rheology modifier used herein is selected from the group consisting of water swellable polymers, non-water soluble crystalline polymers, and mixtures thereof. Preferred water swellable polymers are selected from the group consisting of natural, semi-synthetic or synthetic water swellable polymers, preferably from the group consisting of polyacrylates, polymethacrylates, polyacrylamides, polymethacrylamides, polyurethanes and co-polymers thereof, polysaccharides, cellulose ethers, gums, and mixtures thereof.

Synthetic water swellable polymers can be prepared following different synthesis strategies including (i) polyelectrolyte(s) subjected to covalent cross-linking, (ii) associative polymers consisting of hydrophilic and hydrophobic components (“effective” cross-links through hydrogen bonding), and (iii) physically interpenetrating polymer networks yielding absorbent polymers of high mechanical strength. It is herein understood that the above mentioned strategies are not mutually exclusive. Efforts have focused on tailoring composite gels which are reliant on the balance between polymer-polymer and polymer-solvent interactions under various stimuli including changes in temperature, pH, ionic strength, solvent, concentration, pressure, stress, light intensity, and electric or magnetic fields. Typical examples of synthetics water swellable polymers include but are not limited to polyacrylates, polymethacrylates, polyacrylamides, polymethacrylamides, polyurethanes and co-polymers thereof including hydrophobic modifications.

Naturally originated water swellable polymers include polysaccharides. Suitable polysaccharides may include, but are not limited to, cellulose ethers, guar, guar derivatives, locust bean gum, psyllium, gum arabic, gum ghatti, gum karaya, gum tragacanth, carrageenan, agar, algin, xanthan, scleroglucan, dextran, pectin, starch, chitin and chitosan.

Semi-synthetic guar derivatives for use in the invention include carboxymethyl guar (CM guar), hydroxyethyl guar (HE guar), hydroxypropyl guar (HP guar), carboxymethylhydroxypropyl guar (CMHP guar), cationic guar, hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar) and hydrophobically modified cationic guar (HM cationic guar).

Semi-synthetic water swellable polymers include modified cellulose ethers. Cellulose ethers for use in the invention include hydroxyethyl cellulose (HEC), hydroxypropyl cellulose (HPC), water soluble ethylhydroxyethyl cellulose (EHEC), carboxymethyl cellulose (CMC), carboxymethylhydroxyethyl cellulose (CMHEC), hydroxypropylhydroxyethyl cellulose (HPHEC), methyl cellulose (MC), methylhydroxypropyl cellulose (MHPC), methylhydroxyethyl cellulose (MHEC), carboxymethylmethyl cellulose (CMMC), hydrophobically modified carboxymethyl cellulose (HMCMC), hydrophobically modified hydroxyethyl cellulose (HMHEC), hydrophobically modified hydroxypropyl cellulose (HMHPC), hydrophobically modified ethylhydroxyethyl cellulose (HMEHEC), hydrophobically modified carboxymethylhydroxyethyl cellulose (HMCMHEC), hydrophobically modified hydroxypropylhydroxyethyl cellulose (HMHPHEC), hydrophobically modified methyl cellulose (HMMC), hydrophobically modified methylhydroxypropyl cellulose (HMMHPC), hydrophobically modified methylhydroxyethyl cellulose (HMMHEC), hydrophobically modified carboxymethylmethyl cellulose (HMCMMC), cationic hydroxyethyl cellulose (cationic HEC) and cationic hydrophobically modified hydroxyethyl cellulose (cationic HMHEC).

Non-water soluble crystalline polymers are preferred in view of the higher weight efficiency and efficacy in delivering high yield in the final finished product. Most preferred is micro-fibrillated microfibrous cellulose, also referred to as micro fibril cellulose (MFC), such as described in US 2008/0108714 (CP Kelco) or US2010/0210501 (P&G), or derivatives thereof: such as bacterially derived, pulp derived or otherwise. Such non-water soluble crystalline polymers can be used to provide suspension of particulates in surfactant-thickened systems as well as in formulations with high surfactant concentrations. When MFC is used as rheology modifier, it is typically present in the finished product at concentrations from about 0.01% to about 1%, but the concentration may vary depending on the desired product. In a preferred embodiment, MFC is used with co-agents such as charged hydrocolloids including but not limited to carboxymethylcellulose or cationically modified guar gum, and/or co-processing agents such as CMC, xanthan gum, and/or guar gum with the microfibrous cellulose. US2008/0108714 describes MFC in combination with xanthan gum, and CMC in a ratio of 6:3:1, and MFC, guar gum, and CMC in a ratio of 3:1:1. These blends allow to prepare MFC as a dry product which can be “activated” with high intensity mixing into water or other water-based solutions. “Activation” typically occurs following the MFC blends are added to water and the co-agents/co-processing agents are hydrated. After the hydration of the co-agents/co-processing agents, high intensity mixing is generally then needed to effectively produce a three-dimensional functional network that exhibits a true yield point. One example of a commercially available MFC is Cellulon® from CPKelko.

When a non-water soluble crystalline polymer is used, addition of a wetting aid will facilitate and speed up the hydration kinetics of the non-soluble polymer. Suitable wetting agents are selected from the group consisting of surfactants, water soluble polymers, humectants, and mixtures thereof.

Most preferred wetting aid is a surfactant, preferably a nonionic surfactant due to its amphiphilic properties. Without being bound by theory it is believed that the nonionic surfactant will place itself in the crystalline-fiber matrix interface and promote hydration by pulling water to the crystalline fibers thanks to the hydrophilic head. It is further believed that the presence of a nonionic surfactant will facilitate the premix generation stage, when present.

### Premix Generation Stage

In one embodiment, following step (c) in the slurry generation stage, the slurry is mixed with a solvent, preferably water, to generate a premix, step (d). Preferably, step (d) is carried out at low intensity mixing.

Low intensity mixing is typically achieved by the use of a static mixer. Such static mixer typically comprises a number of fixed (i.e. non-rotating) elements, preferably helical in shape, enclosed within a tubular housing. The fixed geometric design of the unit can simultaneously or individually produce patterns of flow division and/or radial mixing. By “flow division” it is herein meant that the medium being mixed, in laminar flow, divides at the leading edge of each element of the mixer and follows the channels created by the element shape. At each succeeding element, the two channels are further divided, resulting in an exponential increase in stratification. The number of striations produced is 2ⁿ where ‘n’ is the number of elements in the mixer. By “radial mixing” it is herein meant that the medium being mixed, in turbulent or laminar flow, is circulated around its own hydraulic centre in each channel of the mixer. The medium may be intermixed to reduce or eliminate radial gradients in temperature and velocity. It is understood herein that other suitable processes may be utilized with equipment described in the art such as via, paddle mixer, V-blender, ribbon blender, double cone blender, and so on provided that the intensity of mixing is below 1×10⁶ J/m³.

Without wishing to be bound by theory it is believed that adding water at this stage enables the required hydration while avoiding particles sticking together with resulting gel formation. Indeed particles are sufficiently pre-separated upon slurry making so that strong particle co-agulation is prevented.

In a preferred embodiment the premix is generated in a continuous and/or in-line process set up, to minimize the risk of air entrainment.

### Premix Activation Stage

Particularly when the rheology modifier is micro fibril cellulose (MFC), an activation stage may be introduced in order to expand the fibers and generate the desired reticulated network needed to increase the yield stress and the ability to structure and suspend particles in a final composition.

In one embodiment, following premix generation, step (d), when said rheology modifier is MFC, the premix may be activated at high and/or low intensity mixing.

High intensity mixing may be applied to optimize further rheology modifier reticulated network expansion and to maximize yield stress and weight efficiency, as well as delivering optimum product clarity and/or transparency. Low intensity mixing could be considered to minimize capital and maximize energy efficiency.

In one embodiment, the activation step is carried out at an energy density of above 1.0×10⁶ J/m³, alternatively above 2.0×10⁶ J/m³. In one embodiment, the activation is performed with an energy density from 2.0×10⁶ J/m³ to 5.0×10⁷ J/m³, alternatively from 5.0×10⁶ J/m³ to 2.0×10⁷ J/m³, alternatively from 8.0×10⁶ J/m³ to 1.0×10⁷ J/m³. It has importantly been found that by activating the MFC under the intense high shear processing conditions as set forth herein, that formulations having even below 0.05 wt % of said bacterial cellulose are capable of the desired rheological benefits such as yield stress and particle suspension.

Processing techniques capable of providing this amount of energy density include conventional high shear mixers, static mixers, prop and in-tank mixers, rotor-stator mixers, and Gaulin homogenizers, SONOLATOR® from Sonic Corp of CT. In one embodiment, the step of activating the MFC is performed with a high pressure homogenizer comprising a mixing chamber and a vibrating blade, wherein the feed is forced into the mixing chamber through an orifice. The feed which is under pressure accelerates as it passes through the orifice and comes into contact with the vibrating blade.

In one embodiment, the step of activating said MFC under high intensity mixing involves causing hydrodynamic cavitation achieved using a SONOLATOR®. Without intending to be bound by theory, it is believed that the mixture within the mixing chamber undergoes hydrodynamic cavitation within the mixing chamber causing the MFC to form a cellulose network with sufficient degree of interconnectivity to provide enhanced shear thinning capabilities of the final composition.

It has importantly been found that certain processing conditions enhance the ability of the MFC to provide the desired rheological benefits to the composition, including enhanced yield stress at lower levels of the bacterial cellulose. Without intending to be bound by theory, this benefit is believed to be achieved by increasing the interconnectivity of the bacterial cellulose network formed within the liquid matrix.

In one embodiment, it is desired to perform the activation step (or stage) using conventional mixing technologies such as a batch or continuous in line mixer at energy densities up to about 1.0×10⁶ J/m³.

Another method to enhance the ability of the MFC to form the cellulose network is to contact the slurry and/or premix directly into a feed stream of the liquid actives into the mixing chamber of an ultrasonic homogenizer or in line mixer. An advantage of this embodiment is processing simplicity and cost/space savings.

### Final Mixing Stage

In one embodiment, following step (e) in the premix activation stage, the premix is mixed with the remaining ingredients to generate the final composition, step (f). This could be done in a batch and/or continuous (or in-line) process. Preferably step (f) is carried out in a continuous or in-line process.

Without wishing to be bound by theory it is believed that adding the slurry and/or premix to the remaining ingredients in a in-line process, allows reduced processing time and greater quantity capabilities whilst eliminating the risks of air generation, pipe blocking and difficulties in controlling the powder flow rate, that would otherwise arise if the rehology modifier, particularly MFC, was directly added in an in-line process.

### Optional Absolute Mixing Stage and Absolute Activation Stage

In an embodiment absolute mixing and absolute activation occur substantially simultaneously. In a preferred embodiment absolute mixing occurs prior to absolute activation. Absolute mixing comprises mixing the slurry with the remaining ingredients needed to generate the desired final composition. Absolute activation may comprise high and/or low intensity mixing, preferably high intensity mixing, of the mixture generated in the absolute mixing. High intensity mixing is preferred in the absolute activation stage, as the rheology modifier, preferably MFC, in this case has not been pre-swollen contrary to when a premix generating step is present.

In one embodiment, following step (c) in the slurry generation stage, the slurry is mixed with the remaining ingredients to generate the final composition and is substantially simultaneously or subsequently activated, preferably at high intensity mixing. This step, step (d′), is preferably carried out in a continuous process. The advantage of such embodiment is that production time is reduced since the premix generation step is skipped.

### Composition

The compositions generated by the process according to the present invention are typically heavy or light duty laundry compositions, hand dishwashing detergent compositions, hard surface cleaning and/or personal cleansing compositions. Such compositions may be single phase and/or multiphase and be in liquid and/or gel form.

### Optional Composition Components:

The compositions herein can further comprise a number of other optional ingredients such as but not limited to surfactants, such as anionic, cationic, nonionic, semi-polar and/or zwitterionic surfactants; builders, chelants, conditioning polymers, cleaning polymers, surface modifying polymers, soil flocculating polymers, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, organic and inorganic cations such as alkaline earth metals such as Ca/Mg-ions and diamines, solvents, hydrotropes, suds suppressors/stabilizers/boosters, antibacterial agents, preservatives and pH trimming and buffering means, viscosity trimming agents such as sodium chloride.

### Packaging

The liquid detergent compositions of the present invention may be packed in any suitable packaging for delivering the liquid detergent composition for use. The package may be clear and/or opaque. Such packages are preferably made of glass or plastic. The packaging could be either used normal or upside down.

### Rheology Test Method:

Viscosity is determined by conventional methods, e.g. using an AR 1000 rheometer from TA instruments using a standard-size aluminum DIN or conical concentric cylinder (also called bob & cup). The rheometer settings are: 15 mm stator inner diameter, 14 mm rotor outer radius, 42 mm cylinder immersed height and 5920 μm gap, 3.652 μN·m·s-2. The low shear viscosity at 0.1 s-1 is obtained from a logarithmic shear rate sweep at 20° C. The procedure consists of two steps including a pre-conditioning and a flow ramp up step. The pre-conditioning step consists in a pre-shear at 10 s-1 and 20° C. for 30 sec. The flow ramp up follows immediately and consists in shearing the sample at increasing shear rates in steady state flow mode from 0.1 to 1000 s-1, for 5 points per decade on a logarithmic scale, allowing measurements to stabilize for a period of from 5 s for up to 1 min with a tolerance of 5 percent. The logarithmic plot of the viscosity vs. shear rate of the flow ramp down experiment is used to determine the low shear viscosity at 0.1 s-1.

### Aeration Level/Density Cup Test Method

To characterize the aeration level in a substance, the apparent density is the key parameter. The apparent density is measured via the density cup method at 20° C. and atmospheric pressure.

A pre-calibrated cup is used, the density cup used is manufactured by Gardco (model British standard 100 cc cup) and measurements are taken at 20° C. The density of the substance with air is measured at 2 min intervals until a plateau is reached, this density corresponds to the density of the substance without air.

Sample Analysis
1. Tare the clean and dry cup.
2. Place a sample of the substance in a water bath at 20° C. for it to reach the desired temperature of 20° C.
3. Fill cup completely with sample. Take care to minimize air bubbles or foam.
4. Place lid on cup. Cover vent hole with paper towel to avoid splashing of product.
5. Wipe off exterior of cup assembly, making sure it is clean and dry.
6. Weigh sample cup and record weight.

The density of the substance is determined by dividing the recorded weight by the volume of the calibrated density cup.

The amount of air in the substance is calculated by using the following equation:

$${\%}_{air} = \frac{{ρ}_{substance with no air} - {ρ}_{substance with air}}{{ρ}_{substance with no air}} * 100$$

### EXAMPLES

### Example 1a

### Preparation of the Slurry

A bench top mixing device with a Pitch Blade Turbine impeller (PBT) is used to prepare a slurry of 25% by weight of Micro Fibril Cellulose (EX-9560, manufactured by cPKelco) in 75% by weight of anhydrous liquid Nonionic C91E8 (Neodol 91-8 manufactured by Shell Chemicals UK Ltd.). The trials are conducted using a 500 g beaker and an IKA Werke bench top mixing device (Model Euro-ST P CV, Eurostar power control—visc, manufactured by IKA) using a 4 blade PBT impeller. The MFC powder is added in 2 min and mixed for 5 min at 600 RPM to achieve a homogeneous mixture. The viscosity of the slurry measured at 0.1 s-1 and 20° C. is 0.255 Pa·s (using the test method described herein).

### Example 1b

### Preparation of the Slurry

A bench top mixing device with a Pitch Blade Turbine impeller (PBT) is used to prepare a slurry of 25% by weight of Micro Fibril Cellulose (EX-9560, manufactured by cPKelco) in 75% by weight of anhydrous liquid 1,2-Propylene glycol (manufactured by Dow Chemical Co. Ltd). The trials are conducted using a 500 g beaker and an IKA Werke bench top mixing device (Model Euro-ST P CV, Eurostar power control—visc, manufactured by IKA) using a 4 blade PBT impeller. The MFC powder is added in 2 min and mixed for 5 min at 600 RPM to achieve a homogeneous mixture. The viscosity of the slurry measured at 0.1 s-1 and 20° C. is 0.245 Pa·s (using the test method described herein).

### Example 1c

### Preparation of the Slurry

A batch mixer with a Pitch Blade Turbine impeller (PBT) is used to prepare a slurry of 30% by weight of Xanthan gum (FFCS, manufactured by Jungbunzlauer or Keltrol TF, manufactured by CP Kelco, having a particle size of 92% by weight through 75 microns (Tyler 200 mesh or equivalent)) in 69.3% by weight of anhydrous liquid Nonionic C91E8 (Neodol 91-8 manufactured by Shell Chemicals UK Ltd.) and 0.70% by weight of Citric Acid (50% active in water). The trials are conducted using a 500 g batch and an IKA Werke bench top mixing device (Model Euro-ST P CV, Eurostar power control—visc, manufactured by IKA) using a 4 blade PBT impeller. The Citric Acid is added to the Nonionic and mixed for 1 minute at 100 rpm. Subsequently the Xanthan Gum powder is added in 2 min and mixed for 5 min at 600 RPM to achieve a homogeneous mixture. The viscosity of the slurry measured at 0.1 s-1 and 20° C. is 0.948 Pa·s (for Jungbunzlauer FFCS) and 0.443 Pa·s (for CP Kelco Keltrol TF) (using the test method described herein).

### Example 1d

### Preparation of the Slurry

A batch mixer with a Pitch Blade Turbine impeller (PBT) is used to prepare a slurry of 30% by weight of Xanthan gum (FFCS, manufactured by Jungbunzlauer, having a particle size of 92% by weight through 75 microns (Tyler 200 mesh or equivalent)) in 69.3% by weight of anhydrous liquid Dipropylene Glycol n-Butyl Ether (Dowanol DPnB manufactured by DOW Chemicals) and 0.70% by weight of Citric Acid (50% active in water). The trials are conducted using a 500 g batch and an IKA Werke bench top mixing device (Model Euro-ST P CV, Eurostar power control—visc, manufactured by IKA) using a 4 blade PBT impeller. The Citric Acid is added to the Dipropylene Glycol n-Butyl Ether and mixed for 1 minute at 100 rpm. Subsequently the Xanthan Gum powder is added in 2 min and mixed for 5 min at 600 RPM to achieve a homogeneous mixture. The viscosity of the slurry measured at 0.1 s-1 and 20° C. is 1.887 Pa·s (using the test method described herein).

### Example 1e

### Preparation of the Slurry

A batch mixer with a Pitch Blade Turbine impeller (PBT) is used to prepare a slurry of 30% by weight of Xanthan gum (FFCS, manufactured by Jungbunzlauer, having a particle size of 92% by weight through 75 microns (Tyler 200 mesh or equivalent)) in 69.3% by weight of anhydrous liquid Diethylene Glycol (DEG, manufactured by Sabic Petrochemicals) and 0.70% by weight of Citric Acid (50% active in water). The trials are conducted using a 500 g batch and an IKA Werke bench top mixing device (Model Euro-ST P CV, Eurostar power control—visc, manufactured by IKA) using a 4 blade PBT impeller. The Citric Acid is added to the Diethylene Glycol and mixed for 1 minute at 100 rpm. Subsequently the Xanthan Gum powder is added in 2 min and mixed for 5 min at 600 RPM to achieve a homogeneous mixture. The viscosity of the slurry measured at 0.1 s-1 and 20° C. is 1.795 Pa·s (using the test method described herein).

### Example 2

### Activation of Slurry in a Continuous Process

The slurry of Example 1a is injected into the hand dish base soap (i.e. all remaining ingredients forming the final composition, as shown in Table I). The base soap and slurry are activated at high intensity mixing via a SONOLATOR® from Sonic Corp of CT at an energy density of 7.155×10⁶ J/m³ at 5000 psi.

TABLE I
Base soap example

| Material | % by weight |
|---|---|
| Pigmosol Blue 6900 | 0.008 |
| NaOH (50%) | 0.6 |
| NaCl, (100%) | 2.0 |
| MgCl2 | 0.1 |
| Lial 123A sulfate | 16.0 |
| C12-C13 E3 ethoxylated sulfate | 16.0 |
| Shell A sulfate | 16.0 |
| C12-C14 Amine Oxide | 10.0 |
| Polypropylene glycol 2000, (100%) | 0.2 |
| Acticide M20 (MIT) | 0.016 |
| Phenoxyethanol | 0.4 |
| Perfume | 0.6 |
| Minors | Balance to 100% with water |

### Example 3

### Hydration of the Xanthan Gum in a Continuous Process

The slurry of Example 1c is injected into a continuous water stream at a level of 1.5%. As first step the slurry is dispersed at low energy. This is done most effectively using either 4 static mixer elements or otherwise fully relying on the turbulent flow regime in a pipe. As second step the Xanthan Gum powder from the slurry is hydrated with the water. Dissolution time is dependent on a) effective dispersion as described in the first step, b) the particle size of the Xanthan Gum powder used, c) the electrolyte content of the water, d) the velocity of the continuous flow in a pipe. Hydration time of Xanthan Gum 200 mesh in a water stream at ambient temperature having a velocity of 1 m/s is determined to be: a) less than 15 seconds using osmotised water and, b) less than 60 seconds using osmotised water to which 0.08% by weight of NaOH (50% active in water) has been added to obtain a pH>11.5 for reasons of micro-preservation. Directly after obtaining full hydration of the Xanthan Gum, other electrolytes and ingredient of the final formulation may be added in the continuous process. Alternatively the premix may be stored for later consumption or be processed further in a batch.

### Example 4

### Stability of the Slurry

Tri-sodium citrate dihydrate solution is added to the slurry of Example 1a to extend the physical stability of the slurry and to aid slowing down the settling/caking of the MFC solids. 5.6% of sodium citrate solution (36% Tri-sodium citrate dihydrate solution manufactured by Industrial Chemicals Ltd UK) is added to the slurry of Example 1a using an IKA Werke bench top mixing device (Model Euro-ST P CV, Eurostar power control—visc, manufactured by IKA) using a 4 blade PBT impeller. The sodium citrate solution is added in 1 min and mixed for 5 min at 600 RPM to achieve a homogenous mixture. The viscosity of the slurry at 0.1 s-1 and 20° C. is 2.244 Pa·s (using the test method described herein).

Table II indicates the impact of tri-sodium citrate dihydrate on the MFC slurry phase stability. The samples generated in examples 1a and 4 were left to stand statically at ambient temperature and atmospheric pressure for 6 hrs and visually inspected for height in phase split.

TABBLE II
visual observation of reduced speed of settling.

| | | 5.6% |
|---|---|---|
| | 0% Tri-sodium citrate | Tri-soidum citrate |
| | dihydrate solution | dihydrate solution |
| | (Example 1a) | (Example 4) |
| Reduced speed of settling | NO | YES |
| YES/NO | | |

### Example 5

### Preparation of the Premix

A bench top mixing device with a Pitch Blade Turbine impeller (PBT) is used to prepare a 1.5% MFC premix by using the slurry of Example 1a in water. 6% of MFC slurry from Example 1a is added in a 94% by weight of Water (De-mineralized water from Millipore corporation). The trials are conducted using a 500 g batch and an IKA Werke bench top mixing device (Model Euro-ST P CV, Eurostar power control—visc, manufactured by IKA) using a 4 blade PBT impeller. The MFC slurry from Example 1a is added in 1 min and mixed for 5 min at 600 RPM to achieve a homogeneous mixture.

### Example 6

### Activation of the Premix

### Activation by the Sonolator:

The premix of Example 5 is activated at high intensity mixing via SONOLATOR® from Sonic Corp of CT at an energy density of 7.155×10⁶ J/m³ at 5000 psi.

### Activation by the Ultrasonicator:

The premix of Example 5 is activated with an ultrasonic device from Hielscher UIP1500hd, the energy supplied is 1500 W but can range from 500-16000 W upon the scale of testing. The ultrasonication is carried out in a batch process, but the same process can be carried out in a continuous (or in-line) process via a flow cell.

### Example 7

### Determination of the Saturation Point

A bench top mixing device with a Pitch Blade Turbine impeller (PBT) is used to prepare 3 slurries of 25%, 35% and 45% by weight of Micro Fibril Cellulose (EX-9560, manufactured by cPKelco) in respectively 75%, 65% and 55% by weight of anhydrous liquid Nonionic C91 E8 (Neodol 91-8 manufactured by Shell Chemicals UK Ltd.). The trials are conducted using a 500 g batch and an IKA Werke bench top mixing device (Model Euro-ST P CV, Eurostar power control—visc, manufactured by IKA) using a 4 blade PBT impeller. Viscosity is measured using the test method described herein. The saturation is extrapolated by use of the tangent line on each side of the curve, the cutting point is the extrapolated saturation point. The saturation is reached at 33% by weight of Micro Fibril Cellulose, using the above stated method.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for the production of a rheology modifier containing composition comprising the steps of:
(a) providing a rheology modifier, wherein said rheology modifier is selected from the group consisting of a water swellable polymer, a non-water soluble crystalline polymer, and mixtures thereof;
(b) providing a substantially anhydrous water-miscible liquid carrier; and
(c) dispersing said rheology modifier in said substantially anhydrous water-miscible liquid carrier to generate a slurry having a viscosity of less than 2000 mPas at 0.1 s⁻¹ and 20° C. when measured using an AR 1000 rheometer.

2. A process according to claim 1 wherein said slurry has a viscosity of less than 1000 mPas, measured at 0.1 s⁻¹ and 20° C.

3. A process according to claim 1 wherein said slurry has a viscosity of less than 250 mPas, measured at 0.1 s⁻¹ and 20° C.

4. A process according to claim 1 wherein said water swellable polymer is selected from the group consisting of polyacrylates, polymethacrylates, polyacrylamides, polymethacrylamides, polyurethanes and co-polymers thereof, polysaccharides, cellulose ethers, gums, and mixtures thereof.

5. A process according to claim 1 wherein said water swellable polymer is selected from the group consisting of cellulose ethers, gums, and mixtures thereof.

6. A process according to claim 1 wherein said water swellable polymer is a gum selected from the group consisting of guar gum, xanthan gum, gellan gum and mixtures thereof.

7. A process according to claim 1 wherein said non-water soluble crystalline polymer is micro fibril cellulose (MFC).

8. A process according to claim 1 wherein said non-water soluble crystalline polymer is micro fibril cellulose (MFC) and wherein said micro fibril cellulose (MFC) is combined with a carboxymethylcellulose, a modified carboxymethylcellulose, a quaternized polysaccharide, and mixtures thereof; and optionally, a polymeric thickener selected from xanthum products, pectin, alginates, gellan gum, welan gum, diutan gum, rhamsan gum, carrageenan, guar gum, agar, gum arabic, gum ghatti, karaya gum, gum tragacanth, tamarind gum, locust bean gum, and mixtures thereof.

9. A process according to claim 1 wherein said substantially anhydrous water-miscible liquid carrier is selected from the group consisting of surfactants, humectants, polymers, oils, and mixtures thereof.

10. A process according to claim 1 wherein said substantially anhydrous water-miscible liquid carrier comprises a surfactant.

11. A process according to claim 1 wherein said substantially anhydrous water-miscible liquid carrier consists essentially of a nonionic surfactant.

12. A process according to claim 1 wherein said substantially anhydrous water-miscible liquid consists essentially of a nonionic surfactant selected from alcohol alkoxylates with a hydrophilic-lipophilic balance of greater than 10.

13. A process according to claim 1 wherein said slurry comprises no more than 3% of air.

14. A process according to claim 1 wherein said slurry comprises no more than 0.1% of air.

15. A process according to claim 1 wherein step (c) comprises the step of providing a polyvalent salt and mixing said salt with said rheology modifier and said substantially anhydrous water-miscible liquid carrier.

16. A process according to claim 1 wherein step (c) comprises the step of providing a tri-valent citrate, and mixing said citrate with said rheology modifier and said substantially anhydrous water-miscible liquid carrier.

17. A process according to claim 1 wherein following step (c), the slurry is mixed with remaining ingredients to generate a final composition and wherein said rheology modifier consists of micro fibril cellulose (MFC), and wherein said micro fibril cellulose (MFC) is activated substantially simultaneously, or after, mixing with remaining ingredients to generate a final composition.

18. A process according to claim 1 wherein following step (c), the slurry is mixed with a solvent to generate a premix, step (d) and wherein said rheology modifier consists of micro fibril cellulose (MFC) and wherein said micro fibril cellulose (MFC) is activated substantially simultaneously, or after, mixing with said solvent, optionally said premix containing activated micro fibril cellulose (MFC) is mixed with remaining ingredients to generate a final composition.

19. A process according to claim 1 wherein following step (c), the slurry is mixed with water to generate a premix, step (d) in an in-line process and wherein said rheology modifier consists of micro fibril cellulose (MFC) and wherein said micro fibril cellulose (MFC) is activated substantially simultaneously, or after, mixing with water, optionally said premix containing activated micro fibril cellulose (MFC) is mixed with remaining ingredients to generate a final composition.

20. A process according to claim 1 wherein following step (c), the slurry is mixed with a solvent to generate a premix, step (d) in an in-line process and wherein said rheology modifier consists of micro fibril cellulose (MFC) and wherein said micro fibril cellulose (MFC) is activated substantially simultaneously, or after, mixing with said solvent and said premix containing activated micro fibril cellulose (MFC) is mixed with remaining ingredients to generate a final composition.
